(19) United States
(12) Patent Application Publication
(10) Pub. No.: US 2020/0128163 A1
(43) Pub. Date: Apr. 23, 2020

(54) IMAGING SYSTEM, IMAGING TERMINAL, AND IMAGING METHOD

(71) Applicant: Olympus Corporation, Tokyo (JP)

(72) Inventors: Arata SHINOZAKI, Tokyo (JP); Kensuke ISHII, Tokyo (JP); Saori MATSUMOTO, Tokyo (JP); Yoshitaka SATO, Tokyo (JP); Yusaku FUJITA, Tokyo (JP)

(21) Appl. No.: 16/724,061

(22) Filed: Dec. 20, 2019

Related U.S. Application Data
(63) Continuation of application No. PCT/JP2018/023898, filed on Jun. 22, 2018.

(30) Foreign Application Priority Data
Jun. 26, 2017 (JP) PCTJP2017023362

(51) Int. Cl. H04N 5/232; H04W 84/12

(52) U.S. Cl. CPC H04N 5/232; H04W 84/12

(57) ABSTRACT

An imaging system provided with an imaging terminal and an external server that communicates with the imaging terminal, wherein: when it is determined that the imaging terminal satisfies an imaging condition for a specific g object to be imaged, the imaging system transfers the right to operate the imaging terminal from an operator to the external server; and, when the right to operate is transferred to the external server, the external server controls the performance of an imaging operation by the imaging terminal for imaging the specific object to be imaged and receives the imaged data of the specific object to be imaged from the imaging terminal.

### CROSS REFERENCE TO RELATED APPLICATIONS

This application is a continuation application based on a PCT Patent Application No. PCT/JP2018/023898, filed on Jun. 22, 2018, whose priority is claimed on a PCT Patent Application No. PCT/JP2017/023362, filed on Jun. 26, 2017. The contents of both applications are incorporated herein by reference.

### BACKGROUND

### Technical Field

The present invention relates to an imaging system, an imaging terminal, an imaging method, and a non-transitory computer-readable recording medium in which a computer program is stored.

### Background Art

A home appliance network system that is provided with a plurality of access point devices and can reliably connect a home gateway and home appliances via these access point devices is disclosed in Japanese Unexamined Patent Application, First Publication No. 2008-048224. In this home appliance network system, when a connection with a connected access point device is disconnected, connection attempts are made in order from the higher-order access point device stored in the connection list. There is also a home gateway through which home appliances communicate with application servers on the Internet. For example, there is an access point (AP) for home appliances in each room, and a plurality of APs are all connected to the home gateway. Home appliances have a list of APs. The disconnected AP is downgraded to the lowest level, and scans for connection availability in the order of the list. The connected AP is upgraded to the highest level.

When at least a subject to be photographed or a specific location or scene that includes the subject is defined and it is difficult to permanently install a camera in the location where the subject is located, it is desired to acquire a photographed image by an external server and to confirm whether or not the photographed image is captured appropriately.

### SUMMARY

An imaging system includes: an imaging terminal; and an external server that communicates with the imaging terminal.

When it is determined that the imaging terminal satisfies an imaging condition for a specific object to be imaged, the imaging system transfers a right to operate the imaging terminal from an operator to the external server.

When the right to operate is transferred to the external server, the external server controls a performance of an imaging operation by the imaging terminal for imaging the specific object to be imaged and receives imaging data of the specific object to be imaged from the imaging terminal.

When the imaging terminal recognizes the specific object to be imaged based on the imaging data under a predetermined condition, the right to operate may be transferred from the operator to the external server.

The imaging terminal may recognize the specific object to be imaged by a marker disposed on or around a surface of the s specific object to be imaged.

When at least one of a position of the imaging terminal and an orientation of the imaging terminal meets a predetermined condition, the right to operate the imaging terminal may be transferred from the operator to the external server.

When the imaging terminal determines that the specific object to be imaged satisfies a predetermined condition, a confirmation screen for transferring the right to operate may be presented on a monitor of the imaging terminal, and the right to operate the imaging terminal may be transferred from the operator to the external server by the operator's confirmation instruction on the confirmation screen.

When the right to operate is transferred from the operator to the external server and the external server is performing the imaging operation using the imaging terminal, the imaging terminal may transmit the imaging data to the external server without storing the imaging data in the imaging terminal.

The imaging terminal may be capable of AP mode communication that is direct wireless communication with an external operation terminal.

An operation of the external operation terminal by the operator may be input from the external operation terminal to the imaging terminal.

The imaging terminal may be capable of STA mode communication that is wireless communication via a router with the external server.

When transferring the right to operate the imaging terminal from the operator to the external server, the AP mode communication may be canceled and the STA mode communication may be performed to connect between the imaging terminal and the external server via the router. The external server may perform the imaging operation by controlling the imaging terminal via the router.

The imaging terminal may be capable of at least one of rotating and moving of an imaging part of the imaging terminal.

When the right to operate is transferred, the external server may follow the specific object to be imaged by optically zooming, rotating, or moving the imaging part so that the specific object to be imaged is within an imaging area of the imaging part.

An imaging terminal communicates with an external server in an imaging system.

When it is determined that the imaging terminal satisfies an imaging condition for a specific object to be imaged, a right to operate the imaging terminal is transferred from an operator to the external server.

When the right to operate is transferred to the external server, the imaging terminal may perform an imaging operation of the specific object to be imaged under a control of the external server, and transmit imaging data of the specific object to be imaged to the external server.

An imaging method in an imaging system including an imaging terminal and an external server communicating with the imaging terminal, including: when it is determined that the imaging terminal satisfies an imaging condition for a specific object to be imaged, transferring a right to operate the imaging terminal from an operator to the external server; and, when the right to operate is transferred to the external server, performing, by the external server, an imaging operation of the specific object to be imaged using the imaging terminal, and transmitting imaging data of the specific object to be imaged from the imaging terminal to the external server.

A non-transitory computer-readable recording medium stores a computer program, when executed by a computer, to cause an imaging system including an imaging terminal and an external server communicating with the imaging terminal to execute: when it is determined that the imaging terminal satisfies an imaging condition for a specific object to be imaged, transferring a right to operate the imaging terminal from an operator to the external server; and, when the right to operate is transferred to the external server, performing, by the external server, an imaging operation of the specific object to be imaged using the imaging terminal, and transmitting imaging data of the specific object to be imaged from the imaging terminal to the external server.

According to each aspect described above, by an imaging system including an imaging terminal and an external server capable of communicating with the imaging terminal, after an operator photographs a specific object to be imaged, it is possible to perform an imaging operation of the specific object to be imaged using the external server.

### BRIEF DESCRIPTION OF THE DRAWINGS

FIG. 1 is a block diagram showing a configuration of an imaging system according to an embodiment of the present invention.

FIG. 2 is a block diagram showing a configuration of the imaging system according to the embodiment of the present invention.

FIG. 3 is a block diagram showing a configuration of a wireless terminal of the imaging system according to the embodiment of the present invention.

FIG. 4 is a diagram showing a first example of first information in the imaging system according to the embodiment of the present invention.

FIG. 5 is a diagram showing a second example of the first information in the imaging system according to the embodiment of the present invention.

FIG. 6 is a block diagram showing a configuration of a camera of the imaging system according to the embodiment of the present invention.

FIG. 7 is a block diagram showing a configuration of an external operation terminal of the imaging system according to the embodiment of the present invention.

FIG. 8 is a diagram showing a processing procedure performed by the wireless terminal in the imaging system according to the embodiment of the present invention.

FIG. 9 is a diagram showing a processing procedure performed by the wireless terminal in the imaging system according to the embodiment of the present invention.

FIG. 10 is a diagram showing a processing procedure performed by the wireless terminal in the imaging system according to the embodiment of the present invention.

FIG. 11 is a diagram showing a processing procedure performed by the external operation terminal in the imaging system according to the embodiment of the present invention.

FIG. 12 is a diagram showing a processing procedure performed by the camera in the imaging system according to the embodiment of the present invention.

FIG. 13 is a diagram showing a processing procedure performed by the camera in the imaging system according to the embodiment of the present invention.

FIG. 14 is a diagram showing a processing procedure performed by the camera in the imaging system according to the embodiment of the present invention.

FIG. 15A is an image showing processing of an imaging method using the imaging system according to the embodiment of the present invention.

FIG. 15B is an image showing processing of an imaging method using the imaging system according to the embodiment of the present invention.

FIG. 15C is an image showing processing of an imaging method using the imaging system according to the embodiment of the present invention.

FIG. 16 is a diagram showing an example of a confirmation screen for transferring the right to operate the imaging terminal displayed on the monitor of the imaging terminal in the imaging system according to the embodiment of the present invention.

### DETAILED DESCRIPTION OF THE PREFERRED EMBODIMENTS

Hereinafter, embodiments of the present invention will be described with reference to the drawings. Hereinafter, an example of a wireless communication system having a wireless terminal and a camera will be described. The terminals constituting the imaging system are not limited to cameras. Network services include services that the camera actively accesses and services that the camera is passively accessed. For example, services actively accessed by the camera are social media, an image processing API (Application Programming Interface), and storage. For example, a service in which a camera is passively accessed is an external operation terminal that remotely controls the camera. The network service is not limited to the above example.

### (Configuration of the Imaging System 1)

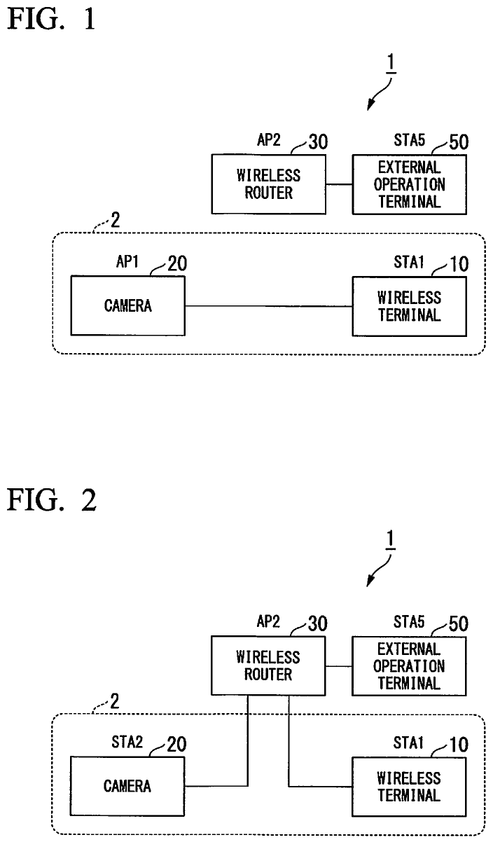

FIGS. 1 and 2 are block diagrams showing the configuration of the imaging system 1 according to the present embodiment. As shown in FIG. 1, the imaging system 1 includes a wireless communication system 2. The wireless communication system 2 includes a wireless terminal 10 and a camera 20 (imaging terminal). The imaging system 1 further includes a wireless router 30 and an external operation terminal 50 (external server).

In the present invention, the camera 20 (imaging terminal) is capable of wireless communication, and is assumed to be, for example, a digital camera, a smartphone, a lens and a smartphone set. The camera 20 (imaging terminal) has a monitor.

The camera 20 (AP1) and the wireless router 30 (AP2) operate as an access point (AP). The wireless terminal 10 (STA1) operates as a station (STA) and establish a P2P connection with the camera 20. The external operation terminal 50 is a network service. The external operation terminal 50 (STA5) operates as an STA and is connected to the wireless router 30. The camera 20 desires communication with the external operation terminal 50. The external operation terminal 50 is connected to the camera 20 via the wireless router 30 and performs remote control of the camera 20 and the like.

When the wireless terminal 10 detects a wireless router 30 that is an AP other than the camera 20, the wireless terminal 10 determines whether or not it is possible to communicate with the external operation terminal 50 to which the camera 20 desires to connect via the wireless router 30. When the wireless terminal 10 determines that communication with the external operation terminal 50 can be performed via the wireless router 30, the wireless terminal 10 transmits connection information of the wireless router 30 to the camera 20. The connection information is an SSID (Service Set Identifier) and a password. For example, the password is an encryption key such as a WEP key and a WPA key.

The wireless terminal 10 instructs the camera 20 to change the mode of the camera 20 from the AP mode to the STA mode. The camera 20 changes the mode to the STA mode. The wireless terminal 10 disconnects the wireless communication connection with the camera 20 and then connects to the wireless router 30 as shown in FIG. 2. After disconnecting the wireless communication connection with the wireless terminal 10, the camera 20 connects to the wireless router 30 as shown in FIG. 2. At this time, the camera 20 uses the connection information received from the wireless terminal 10.

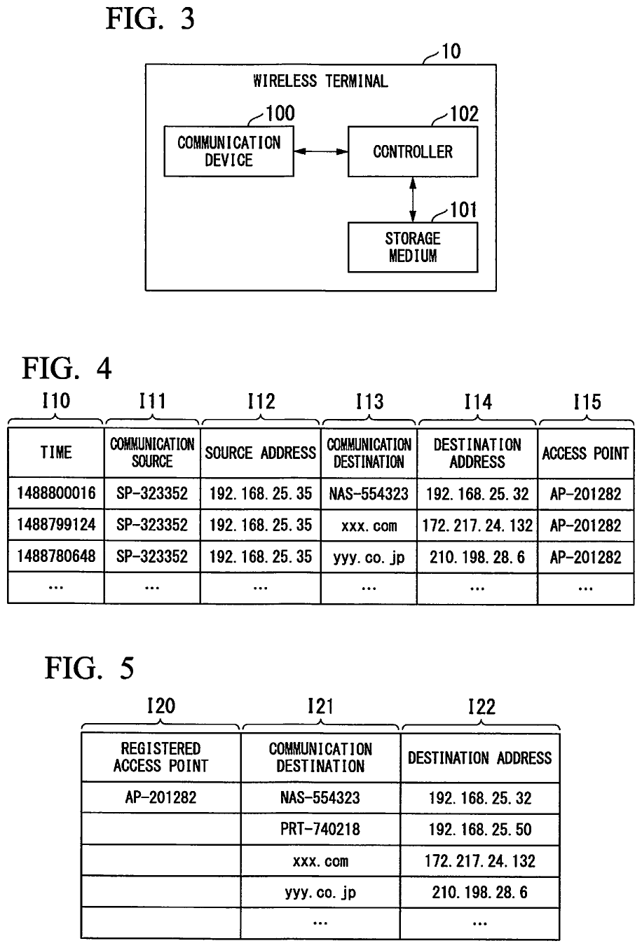

FIG. 3 is a block diagram showing a configuration of the wireless terminal 10 of the imaging system 1 according to the present embodiment. As shown in FIG. 3, the wireless terminal 10 includes a communication device 100, a storage medium 101, and a controller 102.

A schematic configuration of the wireless terminal 10 will be described. A communication terminal operating in the AP mode can accept a wireless communication connection request from another communication terminal. A communication terminal operating in the STA mode cannot accept a wireless communication connection request from another communication terminal, and can request a wireless communication connection from a communication terminal operating in the AP mode. The storage medium 101 stores first information of the wireless router 30. The wireless router 30 can communicate with the external operation terminal 50 and operates in the AP mode. When the wireless terminal 10 is operating in the STA mode, the controller 102 starts a first wireless communication connection with the camera 20 operating in the AP mode.

When the first wireless communication connection with the camera 20 is maintained, the controller 102 detects the wireless router 30. When the wireless router 30 is detected, the controller 102 determines whether or not communication with the external operation terminal 50 can be performed via the detected wireless router 30 based on the first information. When the controller 102 determines that communication with the external operation terminal 50 can be performed via the wireless router 30, the controller 102 transmits second information used for the second wireless communication connection with the wireless router 30 to the camera 20 by the communication device 100. After the second information is transmitted, the controller 102 disconnects the first wireless communication connection with the camera 20. After the first wireless communication connection is disconnected, the controller 102 requests the wireless router 30 for the second wireless communication connection by the communication device 100 using the second information.

As described above, a mode in which a request for wireless communication connection can be received from another communication terminal is defined as an AP mode. As described above, a mode in which a request for wireless communication connection cannot be received from another communication terminal and a wireless communication connection can be requested to a communication terminal operating in the AP mode is defined as a STA mode.

A detailed configuration of the wireless terminal 10 will be described. The communication device 100 is a wireless device. The communication device 100 includes an antenna. Alternatively, the communication device 100 and the antenna are configured separately, and the communication device 100 is connected to the antenna. The communication device 100 performs wireless communication with the camera 20 and the wireless router 30.

The storage medium 101 is a volatile or non-volatile storage device. For example, the storage medium 101 is at least one of a RAM (Random Access Memory), a DRAM (Dynamic Random Access Memory), a SRAM (Static Random Access Memory Memory), an EPROM (Erasable Program Memory Read Memory), EEPROM (Electrically Erasable Programmable Read-Only Memory), flash memory, and hard disk drive. The storage medium 101 stores the first information and the second information.

FIG. 4 is a diagram showing a first example of the first information in the imaging system 1 according to the present embodiment. The first information shown in FIG. 4 is a communication history when the wireless terminal 10 communicates with another communication terminal via the wireless router 30. The first information shown in FIG. 4 includes a communication history when the wireless terminal 10 communicates with the external operation terminal 50 via the wireless router 30.

The communication history includes time I10, communication source I11, communication source address I12, communication destination I13, communication destination address I14, and access point I15. Each piece of information is associated with each other. Time I10 indicates the time at which communication was performed. For example, the time I10 is expressed in a format common to operating systems. The communication source I11 indicates the host name of the communication source terminal. The communication source terminal is the wireless terminal 10. The host name of the wireless terminal 10 is SP-323352. The communication source address I12 is the IP address of the communication source terminal. The IP address of the wireless terminal 10 is 192.168.25.35.

The communication destination I13 indicates the host name of the communication destination terminal. The communication destination terminal is a communication partner of the wireless terminal 10. The host name of the external operation terminal 50 is NAS-554323. The communication destination address I14 is an IP address of a communication destination terminal. The IP address of the external operation terminal 50 is 192.168.25.32. The access point I15 is the SSID of the wireless router 30. The SSID of the wireless router 30 is AP-201282.

FIG. 5 is a diagram showing a second example of the first information in the imaging system 1 according to the present embodiment. The first information shown in FIG. 5 is terminal information indicating terminals that can be passed through when the wireless terminal 10 communicates with the external operation terminal 50.

The terminal indicated by the terminal information is an access point having a fixed ID (SSID or the like) in a home network or the like. Also, the network service connected to the network in which the terminal exists is known. The terminal information includes a registered access point I20, a communication destination I21, and a communication destination address I22. Each piece of information is associated with each other. The registered access point I20 is the SSID of the wireless router 30. The SSID of the wireless router 30 is AP-201282. The communication destination I21 indicates the host name of the communication destination terminal. The host name of the external operation terminal 50 is NAS-554323. The communication destination address I22 is the IP address of the communication destination terminal. The IP address of the external operation terminal 50 is 192.168.25.32.

The communication destination I21 also includes a host name such as a network printer not shown in FIG. 1. The host name of the network printer is PRT-740218. The communication destination address I22 also includes an IP address such as a network printer. The IP address of the network printer is 192.168.25.50.

The second information is connection information. For example, the connection information is an SSID and a password. The wireless terminal 10 has communicated with the external operation terminal 50 via the wireless router 30 in the past. For this reason, a password necessary for wireless communication connection with the wireless router 30 is held in the storage medium 101.

The controller 102 (control unit) includes at least one of a processor and a logic circuit. For example, the processor is at least one of a CPU (Central Processing Unit), a DSP (Digital Signal Processor), and a GPU (Graphics Processing Unit). For example, the logic circuit is at least one of ASIC (Application Specific Integrated Circuit) and FPGA (Field-Programmable Gate Array). The controller 102 can include one or more processors. The controller 102 can include one or more logic circuits. The controller 102 operates according to a program stored in a ROM (not shown). Thereby, the controller 102 controls the operation of the wireless terminal 10.

For example, the function of the controller 102 can be realized as a function of software when the controller 102 reads and executes a program including an instruction defining the operation of the controller 102. This program may be provided by a “computer-readable storage medium” such as a flash memory. Further, the above-described program may be transmitted to the wireless terminal 10 from a computer having a storage device in which the program is stored, via a transmission medium, or by a transmission wave in the transmission medium. A “transmission medium” for transmitting a program is a medium having a function of transmitting information, such as a network (communication network) such as the Internet or a communication line (communication line) such as a telephone line. Further, the above-described program may realize a part of the functions described above. Further, the above-described program may be a difference file (difference program) that can realize the above-described function in combination with a program already recorded in the computer.

The controller 102 transmits information to another communication terminal through the communication device 100. Specifically, the controller 102 controls the communication device 100 so that information is transmitted to another communication terminal. That is, the controller 102 causes the communication device 100 to transmit information for other communication terminals. As a result, the communication device 100 transmits information to another communication terminal. The controller 102 receives information from another communication terminal by the communication device 100. Specifically, the controller 102 controls the communication device 100 so that information is received from another communication terminal. That is, the controller 102 causes the communication device 100 to receive information transmitted from another communication terminal. As a result, the communication device 100 receives information from another communication terminal.

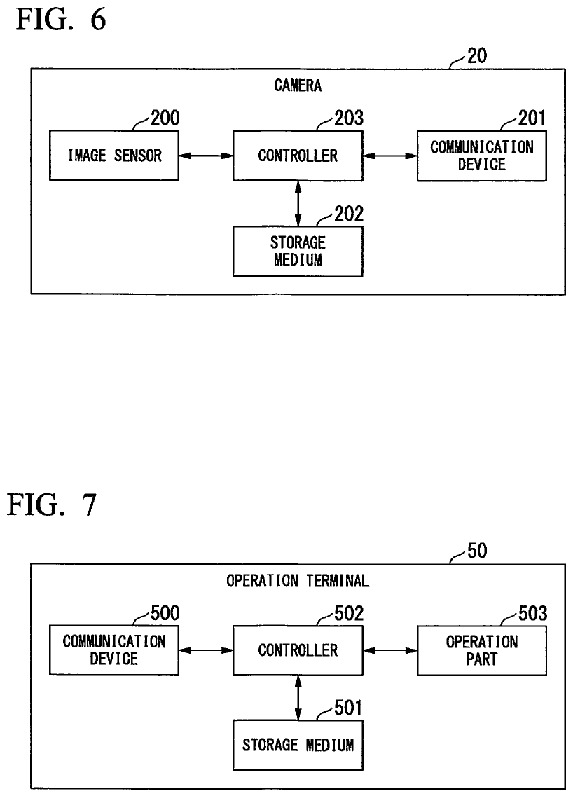

FIG. 6 is a block diagram showing a configuration of the camera 20 of the imaging system 1 according to the present embodiment. As shown in FIG. 6, the camera 20 (imaging terminal) includes an image sensor 200, a communication device 201, a storage medium 202, and a controller 203.

A schematic configuration of the camera 20 will be described. The controller 203 receives the second information from the wireless terminal 10 by the communication device 201. After the second information is received and the first wireless communication connection with the wireless terminal 10 is disconnected, the camera 20 ends the AP mode operation and starts the STA mode operation. After the camera 20 starts operation in the STA mode, the controller 203 requests the wireless router 30 for the third wireless communication connection by the communication device 201 using the second information.

A detailed configuration of the camera 20 will be described. The image sensor 200 is an image sensor. The image sensor 200 performs imaging and generates image data. The generated image data is recorded in the storage medium 202. Note that the image sensor 200 is not essential for the camera 20, and the camera 20 may receive data captured by the image sensor 200 wirelessly or by wire.

The communication device 201 is a wireless device. The communication device 201 includes an antenna. Alternatively, the communication device 201 and the antenna are configured separately, and the communication device 201 is connected to the antenna. The communication device 201 performs wireless communication with the wireless terminal 10 and the wireless router 30.

The storage medium 202 is a volatile or non-volatile storage device. For example, the storage medium 202 is at least one of RAM, DRAM, SRAM, EPROM, EEPROM, flash memory, and hard disk drive. The storage medium 202 stores the image data output from the image sensor 200, the second information received from the wireless terminal 10, and the mode of the camera 20.

The controller 203 is composed of at least one of a processor and a logic circuit. The controller 203 can include one or more processors. The controller 203 can include one or more logic circuits. The controller 203 operates according to a program stored in a ROM (not shown). Thereby, the controller 203 controls the operation of the camera 20.

The controller 203 may read a program including instructions that define the operation of the controller 203 and execute the read program. That is, the function of the controller 203 may be realized by software. This program can be realized in the same manner as the program for realizing the function of the controller 102 shown in FIG. 3.

The controller 203 transmits information to other communication terminals via the communication device 201. Specifically, the controller 203 controls the communication device 201 so that information is transmitted to another communication terminal. That is, the controller 203 causes the communication device 201 to transmit information for other communication terminals. As a result, the communication device 201 transmits information to another communication terminal. The controller 203 receives information from another communication terminal by the communication device 201. Specifically, the controller 203 controls the communication device 201 so that information is received from another communication terminal. That is, the controller 203 causes the communication device 201 to receive information transmitted from another communication terminal. As a result, the communication device 201 receives information from another communication terminal.

The wireless terminal 10 and the camera 20 are connected to each other via the wireless router 30. The wireless terminal 10 acquires the address information of the camera 20 from the storage medium 101. The wireless terminal 10 and the external operation terminal 50 are connected via the wireless router 30. The wireless terminal 10 transmits the address information and communication instruction of the camera 20 to the external operation terminal 50. The communication instruction indicates an instruction for communication with the camera 20. The external operation terminal 50 is a terminal in the private network. Even when the address information of the camera 20 is a private address, the external operation terminal 50 can access the camera 20. The external operation terminal 50 is connected to the camera 20 via the wireless router 30, and performs control of imaging, request of transfer of image data, or the like.

Specifically, after the fourth wireless communication connection with the camera 20 is started, the controller 102 transmits a communication instruction for instructing communication with the camera 20 by the communication device 100 via the wireless router 30 to the external operation terminal. 50.

After the third wireless communication connection with the wireless router 30 is started, the controller 203 transmits the sixth information used for communicating with the camera 20 via the wireless router 30, to the wireless terminal 10 via the wireless router 30 by the communication device 201. After the second wireless communication connection with the wireless router 30 is started and the fourth wireless communication connection with the camera 20 is started, the controller 102 receives the sixth information from the camera 20 via the wireless router 30 by the communication device 100. After the sixth information is received, the controller 102 transmits the sixth information to the external operation terminal 50 via the wireless router 30 by the communication device 100. In the following example, the sixth information is address information of the camera 20.

FIG. 7 is a block diagram showing a configuration of the external operation terminal 50 of the imaging system 1 according to the present embodiment. As shown in FIG. 7, the external operation terminal 50 includes a communication device 500, a storage medium 501, a controller 502, and an operation unit 503.

The communication device 500 is a wireless device. The communication device 500 includes an antenna. Alternatively, the communication device 500 and the antenna are configured separately, and the communication device 500 is connected to the antenna. The communication device 500 performs wireless communication with the wireless terminal 10 and the camera 20 via the wireless router 30.

The storage medium 501 is a volatile or non-volatile storage device. The storage medium 501 is at least one of RAM, DRAM, SRAM, EPROM, EEPROM, flash memory, and hard disk drive. The storage medium 501 stores the address information of the camera 20 received from the wireless terminal 10.

The controller 502 (control unit) includes at least one of a processor and a logic circuit. The controller 502 can include one or more processors. The controller 502 can include one or more logic circuits. The controller 502 operates according to a program stored in a ROM (not shown). Thereby, the controller 502 controls the operation of the external operation terminal 50.

The controller 502 may read a program including instructions that define the operation of the controller 502 and execute the read program. That is, the function of the controller 502 may be realized by software. This program can be realized in the same manner as the program for realizing the function of the controller 102 shown in FIG. 3.

The operation unit 503 is a user interface. For example, the user interface is at least one of a button, a switch, a key, a mouse, a joystick, a touch pad, a trackball, and a touch panel. The operation unit 503 receives a user operation and outputs information corresponding to the user operation content to the controller 502. The operation unit 503 is not essential in the external operation terminal 50. The external operation terminal 50 may have a display.

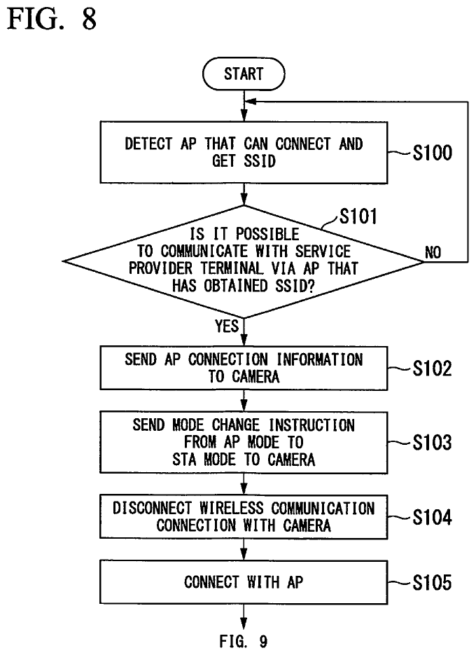

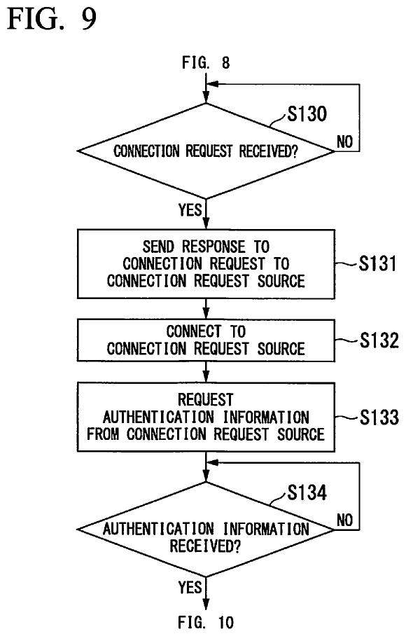

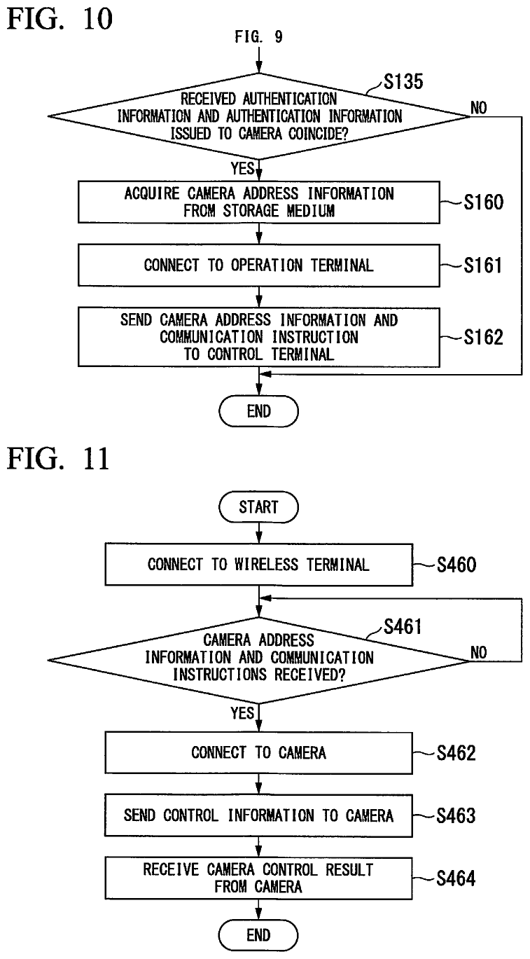

FIGS. 8 to 10 are diagrams showing processing procedures performed by the wireless terminal 10 in the imaging system 1 according to the present embodiment. The operation of the wireless terminal 10 will be described with reference to FIGS. 8 to 10. Before the process shown in FIG. 8 is started, the wireless terminal 10 starts the operation in the STA mode. When the wireless terminal 10 is operating in the STA mode, the controller 102 starts a wireless communication connection with the camera 20 operating in the AP mode. At the timing when the process shown in FIG. 8 is started, the wireless communication connection between the wireless terminal 10 and the camera 20 is maintained.

The controller 102 detects an access point (AP) that can be connected by the communication device 100 and acquires the SSID of the AP. For example, the controller 102 periodically measures the RSSI (Received Signal Strength Indicator) strength of a beacon transmitted by a wireless terminal existing around the wireless terminal 10. The controller 102 checks whether or not the measured RSSI intensity is greater than or equal to a reference value. For example, the reference value is −50 dBm. When the measured RSSI intensity is greater than or equal to the reference value, the controller 102 detects the AP. The controller 102 acquires the SSID from the beacon that the AP periodically transmits (step S100).

After step S100, the controller 102 determines whether or not communication with the service providing terminal can be performed via the AP that has acquired the SSID (step S101). In the imaging system 1 shown in FIG. 1, the service providing terminal is an external operation terminal 50 connected to the wireless router 30.

For example, in step S101, the communication history shown in FIG. 4 or the terminal information shown in FIG. 5 is used. For example, the controller 102 causes the communication history shown in FIG. 4, to select an access point I15 associated with the communication destination I13 corresponding to the target network service. When the target network service is a network storage, the controller 102 selects the access point I15 associated with the communication destination I13, in which the host name of the external operation terminal 50 is registered.

Alternatively, the controller 102 selects the access point I20 associated with the communication destination I21 corresponding to the target network service in the terminal information shown in FIG. 5. When the target network service is a network storage, the controller 102 selects the access point I20 associated with the communication destination I21, in which the host name of the external operation terminal 50 is registered.

For example, the target network service is a default service registered in advance. The target network service may be a service used by an application performed on the wireless terminal 10. When such information corresponding to the target network service is not included in the communication history or terminal information, the wireless terminal 10 cannot communicate with the service providing terminal. When information corresponding to the target network service is included in the communication history or the terminal information, the wireless terminal 10 can communicate with the service providing terminal.

In step S101, the controller 102 determines whether or not communication with the external operation terminal 50 can be performed. In step S101, when the controller 102 determines that communication with the service providing terminal cannot be performed via the AP that has acquired the SSID, the process in step S100 is performed. In step S101, when the controller 102 determines that communication with the service providing terminal can be performed via the AP that has acquired the SSID, the controller 102 reads AP connection information from the storage medium 101. The controller 102 transmits AP connection information to the camera 20 through the communication device 100. That is, the detection of the wireless router 30 that is an AP becomes a trigger, and the connection information of the wireless router 30 is sent to the camera 20 (step S102). The AP connection information is used by the camera 20 for wireless communication connection with the wireless router 30.

After step S102, the controller 102 transmits to the camera 20 by instructing the communication device 100 of the mode change from AP mode to STA mode (step S103).

After step S103, the controller 102 disconnects the wireless communication connection with the camera 20 (step S104).

After step S104, the controller 102 requests the wireless router 30 for wireless communication connection by the communication device 100 using the same connection information as the connection information transmitted to the camera 20 in step S102. Thereby, the controller 102 is connected to the wireless router 30 by the communication device 100 (step S105).

When the camera 20 is configured to change the mode from the AP mode to the STA mode based on the reception of the connection information, the process in step S103 may not be performed. Therefore, the process in step S103 is not essential.

In step S102, the controller 102 generates authentication information and transmits the AP connection information and authentication information to the camera 20 by the communication device 100. In this example, the authentication information is an access token. The generated authentication information is recorded in the storage medium 101.

When a connection request is transmitted from the camera 20, the controller 102 receives the connection request from the camera 20 via the wireless router 30 by the communication device 100. Thereby, the controller 102 receives a connection request from the camera 20 via the wireless router 30 by the communication device 100. After step S105, the controller 102 monitors the communication device 100 and determines whether or not a connection request has been received (step S130).

In step S130, when the controller 102 determines that a connection request has not been received, the determination in step S130 is repeated. In step S130, when the controller 102 determines that a connection request has been received, the controller 102 transmits a response to the connection request to the camera 20 that is the transmission source of the connection request via the wireless router 30 by the communication device 100 (step S131).

After step S131, the controller 102 connects to the camera 20 that is the transmission source of the connection request via the wireless router 30 by the communication device 100 (step S132). In step S132, the controller 102 connects to the camera 20 in the application layer in the OSI reference model. Alternatively, in step S132, the controller 102 completes preparation for communication in the application layer by connecting to the camera 20 in a layer higher than the network layer in the OSI reference model. That is, in step S132, the controller 102 connects to the camera 20 in the second layer higher than the first layer connected to the wireless router 30.

After step S132, the controller 102 transmits the authentication information request to the camera 20 that is the transmission source of the connection request via the wireless router 30 by the communication device 100. Thus, the controller 102 requests authentication information from the camera 20 (step S133).

When the authentication information is transmitted from the camera 20, the controller 102 receives the authentication information from the camera 20 via the wireless router 30 by the communication device 100. After step S133, the controller 102 monitors the communication device 100 and determines whether or not authentication information has been received from the camera 20 (step S134).

When the controller 102 determines that the authentication information is not received from the camera 20 in step S134, the determination in step S134 is repeated. When the controller 102 determines that the authentication information has been received from the camera 20 in step S134, the controller 102 reads the authentication information issued to the camera 20 from the storage medium 101. The controller 102 compares the received authentication information with the authentication information issued to the camera 20. Thereby, the controller 102 determines whether or not two authentication information correspond (step S135).

In step S135, when the controller 102 determines that the two pieces of authentication information do not correspond, the process shown in FIG. 10 ends. In step S135, when the controller 102 determines that the two pieces of authentication information correspond, the process in FIG. 10 is performed.

The process from step S133 to step S135 is not essential. The authentication information may not be transmitted from the wireless terminal 10 to the camera 20 together with the AP connection information.

The connection request received in step S130 includes the address information of the camera 20. Therefore, in step S130, the controller 102 receives the address information of the camera 20 from the camera 20 via the wireless router 30 by the communication device 100. That is, before the connection with the camera 20 is started, the controller 102 receives the address information of the camera 20 from the camera 20 via the wireless router 30 by the communication device 100. The address information of the camera 20 received from the camera 20 is recorded in the storage medium 101.

In step S135, when the controller 102 determines that the received authentication information corresponds with the authentication information issued to the camera 20, the controller 102 reads the address information of the camera 20 from the storage medium 101 to acquire the address information of the camera 20 (step S160). The address information of the camera 20 included in the connection request received from the camera 20 in step S130 is recorded in the storage medium 101. In step S160, that address information is acquired.

After step S160, the controller 102 acquires the communication destination address of the external operation terminal 50 from the communication history shown in FIG. 4 or the terminal information shown in FIG. 5. The controller 102 connects to the external operation terminal 50 via the wireless router 30 by the communication device 100 using the acquired communication destination address. For example, the controller 102 connects to the external operation terminal 50 by transmitting a connection request to the external operation terminal 50 via the wireless router 30 by the communication device 100 (step S161). After step S160, the controller 102 may disconnect the wireless communication connection with the camera 20. In step S161, the controller 102 may connect to the external operation terminal 50 while maintaining the wireless communication connection with the camera 20.

In step S161, the controller 102 connects to the external operation terminal 50 in the application layer in the OSI reference model. Alternatively, in step S161, the controller 102 completes preparation for communication in the application layer by connecting to the external operation terminal 50 in a layer higher than the network layer in the OSI reference model. That is, in step S161, the controller 102 connects to the external operation terminal 50 in the second layer higher than the first layer connected to the wireless router 30.

After step S161, the controller 102 transmits the address information and communication instruction of the camera 20 to the external operation terminal 50 via the wireless router 30 by the communication device 100 (step S162).

FIG. 11 is a diagram showing a processing procedure performed by the external operation terminal 50 in the imaging system 1 according to the present embodiment. The operation of the external operation terminal 50 will be described with reference to FIG. 11.

When the connection request is transmitted from the wireless terminal 10, the controller 502 receives the connection request from the wireless terminal 10 via the wireless router 30 by the communication device 500. Thereby, the controller 502 receives a connection request from the wireless terminal 10 via the wireless router 30 by the communication device 500. The controller 502 connects to the wireless terminal 10 via the wireless router 30 by the communication device 500 (step S460).

When the address information and communication instruction of the camera 20 are transmitted from the wireless terminal 10, the controller 502 receives the address information and communication instruction of the camera 20 from the wireless terminal 10 by the communication device 500. After step S460, the controller 502 monitors the communication device 500 and determines whether or not the address information and communication instruction of the camera 20 are received from the wireless terminal 10 (step S461).

In step S461, when the controller 502 determines that the address information and communication instruction of the camera 20 are not received from the wireless terminal 10, the determination in step S461 is repeated. In step S461, when the controller 502 determines that the address information and communication instruction of the camera 20 have been received from the wireless terminal 10, the controller 502 connects to the camera 20 via the wireless router 30 by the communication device 500 using the address information of the camera 20 (step S462). After step S460, the controller 502 may disconnect the wireless communication connection with the wireless terminal 10. In step S462, the controller 502 may connect to the camera 20 while maintaining the wireless communication connection with the wireless terminal 10.

After step S462, the controller 502 transmits control information corresponding to the operation content by the user to the camera 20 via the wireless router 30 by the communication device 500 (step S463).

After step S463, the controller 502 receives the control result in the camera 20 from the camera 20 via the wireless router 30 by the communication device 500 (step S464).

When the external operation terminal 50 holds the fixed address information of the camera 20 as a known value, the external operation terminal 50 can be directly connected to the camera 20 via the wireless router 30. Therefore, the process in step S160 shown in FIG. 10 and the transmission of address information in step S162 are not essential. Similarly, reception of address information in step S461 shown in FIG. 11 is not essential.

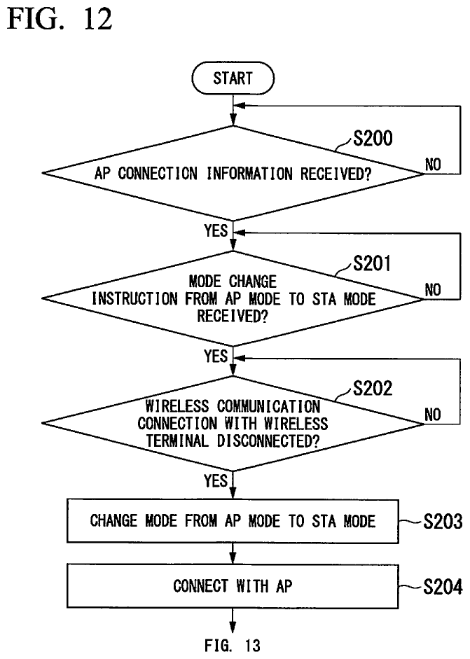

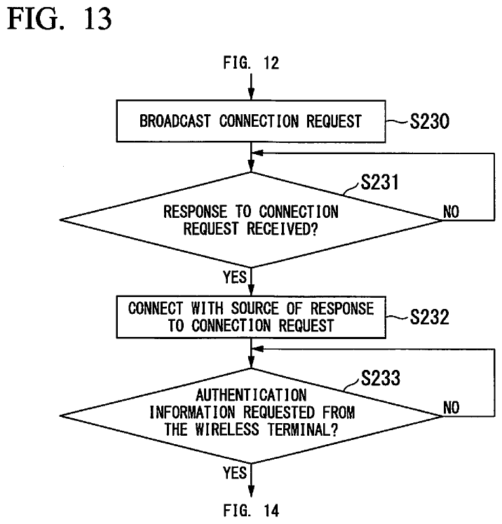

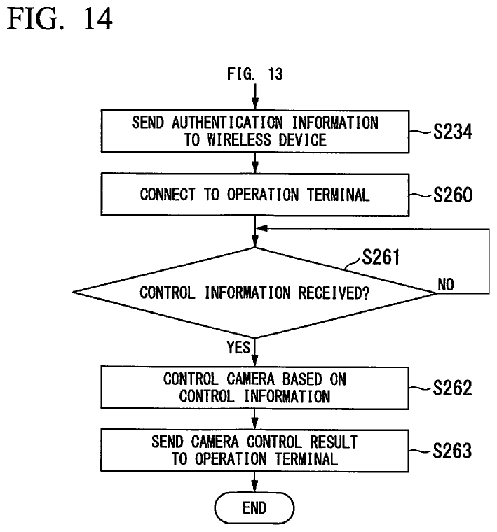

FIGS. 12 to 14 are diagrams showing processing procedures performed by the camera 20 in the imaging system 1 according to the present embodiment. The operation of the camera 20 will be described with reference to FIGS. 12 to 14. At the timing when the process shown in FIG. 12 is started, the camera 20 is operating in the AP mode. The mode of the camera 20 stored in the storage medium 202 indicates the AP mode.

When the AP connection information is transmitted from the wireless terminal 10, the controller 203 receives the AP connection information from the wireless terminal 10 by the communication device 201. The received AP connection information is recorded in the storage medium 202. When the mode change instruction is transmitted from the wireless terminal 10, the controller 203 receives the mode change instruction from the wireless terminal 10 by the communication device 201. The controller 203 monitors the communication device 201 and determines whether or not AP connection information has been received from the wireless terminal 10 (step S200).

In step S200, when the controller 203 determines that AP connection information has not been received from the wireless terminal 10, the determination in step S200 is repeated. In step S200, when the controller 203 determines that AP connection information has been received from the wireless terminal 10, the controller 203 monitors the communication device 201 and determines whether or not a mode change instruction has been received from the wireless terminal 10 (step S201). The object of determination in step S201 is an instruction to change the mode from the AP mode to the STA mode.

In step S201, when the controller 203 determines that a mode change instruction has not been received from the wireless terminal 10, the determination in step S201 is repeated. In step S201, when the controller 203 determines that the mode change instruction has been received from the wireless terminal 10, the controller 203 determines whether or not the wireless communication connection with the wireless terminal 10 has been disconnected (step S202).

In step S202, when the controller 203 determines that the wireless communication connection with the wireless terminal 10 has not been disconnected, the determination in step S202 is repeated. In step S202, when the controller 203 determines that the wireless communication connection with the wireless terminal 10 has been disconnected, the controller 203 changes the mode of the camera 20 stored in the storage medium 202 from the AP mode to the STA mode. As a result, the camera 20 ends the AP mode operation and starts the STA mode operation (step S203).

After step S203, the controller 203 uses the AP connection information received from the wireless terminal 10 to request the wireless router 30 for wireless communication connection by the communication device 201. As a result, the controller 203 connects to the wireless router 30 via the communication device 201 (step S204).

When the camera 20 is configured to change the mode from the AP mode to the STA mode based on the reception of the AP connection information, the process in step S201 may not be performed. Therefore, the process in step S201 is not essential.

After the process in step S105 and step 204 is performed, the wireless terminal 10 and the camera 20 can be connected to each other via the wireless router 30. Therefore, the wireless terminal 10 and the camera 20 can be reconnected.

In step S200, the controller 203 receives authentication information from the wireless terminal 10 by the communication device 201. The authentication information received from the wireless terminal 10 is recorded in the storage medium 202.

After step S204, the controller 203 broadcasts a connection request via the wireless router 30 by the communication device 201. As a result, the controller 203 transmits a connection request to the wireless terminal 10 via the wireless router 30 by the communication device 201. That is, the controller 203 requests connection to the wireless terminal 10 via the wireless router 30 by the communication device 201 (step S230).

When a response to the connection request is transmitted from the wireless terminal 10, the controller 203 receives the response to the connection request from the wireless terminal 10 via the wireless router 30 by the communication device 201. After step S230, the controller 203 monitors the communication device 201 and determines whether or not a response to the connection request has been received from the wireless terminal 10 (step S231).

In step S231, when the controller 203 determines that a response to the connection request has not been received from the wireless terminal 10, the determination in step S231 is repeated. In step S231, when the controller 203 determines that a response to the connection request has been received from the wireless terminal 10, the controller 203 connects to the wireless terminal 10 via the wireless router 30 by the communication device 201 (step S232). In step S232, the controller 203 connects to the wireless terminal 10 in the application layer in the OSI reference model. Alternatively, in step S232, the controller 203 completes preparation for communication in the application layer by connecting to the wireless terminal 10 in a layer higher than the network layer in the OSI reference model. That is, in step S232, the controller 203 connects to the wireless terminal 10 in the second layer higher than the first layer connected to the wireless router 30.

When the authentication information request is transmitted from the wireless terminal 10, the controller 203 receives the authentication information request from the wireless terminal 10 via the wireless router 30 by the communication device 201. After step S232, the controller 203 monitors the communication device 201 and determines whether or not an authentication information request has been received from the wireless terminal 10. That is, the controller 203 determines whether or not authentication information is requested from the wireless terminal 10 (step S233).

When the authentication information request is not received from the wireless terminal 10 in step S233, the controller 203 determines that the authentication information is not requested from the wireless terminal 10. In that case, the determination in step S233 is repeated. In step S233, when the authentication information request is received from the wireless terminal 10, the controller 203 determines that the authentication information is requested from the wireless terminal 10. In that case, the controller 203 reads the authentication information from the storage medium 202. The controller 203 transmits the authentication information to the wireless terminal 10 via the wireless router 30 by the communication device 201 (step S234).

After step S234, the process in FIG. 14 is performed.

The process in step S233 and step S234 is not essential.

The connection request transmitted in step S230 includes the address information of the camera 20. Therefore, in step S230, the controller 203 transmits the address information of the camera 20 to the wireless terminal 10 via the wireless router 30 by the communication device 201. That is, before the connection with the wireless terminal 10 is started, the controller 203 transmits the address information of the camera 20 to the wireless terminal 10 via the wireless router 30 by the communication device 201.

When the connection request is transmitted from the external operation terminal 50, the controller 203 receives the connection request from the external operation terminal 50 via the wireless router 30 by the communication device 201. Thus, the controller 203 receives a connection request from the external operation terminal 50 via the wireless router 30 by the communication device 201. After step S234, the controller 203 is connected to the external operation terminal 50 via the wireless router 30 by the communication device 201 (step S260). After step S234, the controller 203 may disconnect the wireless communication connection with the wireless terminal 10. In step S260, the controller 203 may connect to the external operation terminal 50 while maintaining the wireless communication connection with the wireless terminal 10.

When the control information is transmitted from the external operation terminal 50, the controller 203 receives the control information from the external operation terminal 50 via the wireless router 30 by the communication device 201. The controller 203 monitors the communication device 201 and determines whether or not control information has been received from the external operation terminal 50 (step S261).

In step S261, when the controller 203 determines that control information has not been received from the external operation terminal 50, the determination in step S261 is repeated. In step S261, when the controller 203 determines that control information has been received from the external operation terminal 50, the controller 203 controls the camera 20 based on the received control information (step S262). For example, the control information indicates the start of photographing by the image sensor 200. In step S262, the controller 203 controls the image sensor 200 based on the control information.

After step S262, the controller 203 transmits the control result to the external operation terminal 50 via the wireless router 30 by the communication device 201 (step S263).

The authentication information received from the camera 20 in step S134 includes the address information of the camera 20. The authentication information transmitted to the wireless terminal 10 in step S234 includes the address information of the camera 20.

In the present embodiment, the right to operate can be transferred to the external operation terminal 50 that is more suitable for the operation of the camera 20. For example, the camera 20 is a portable terminal such as a smartphone, and the external operation terminal 50 is a fixed terminal such as a personal computer. When the external operation terminal 50 has a display, the user can confirm an image on a large screen. Alternatively, the user can make detailed imaging settings on the external operation terminal 50.

In the present embodiment, the wireless terminal 10 transmits the address information of the camera 20 to the external operation terminal 50. Therefore, even in an environment where addresses are dynamically assigned, the external operation terminal 50 can communicate with the intended party.

### (Imaging Method)

Next, an imaging method using the imaging system 1 having the above configuration will be described.

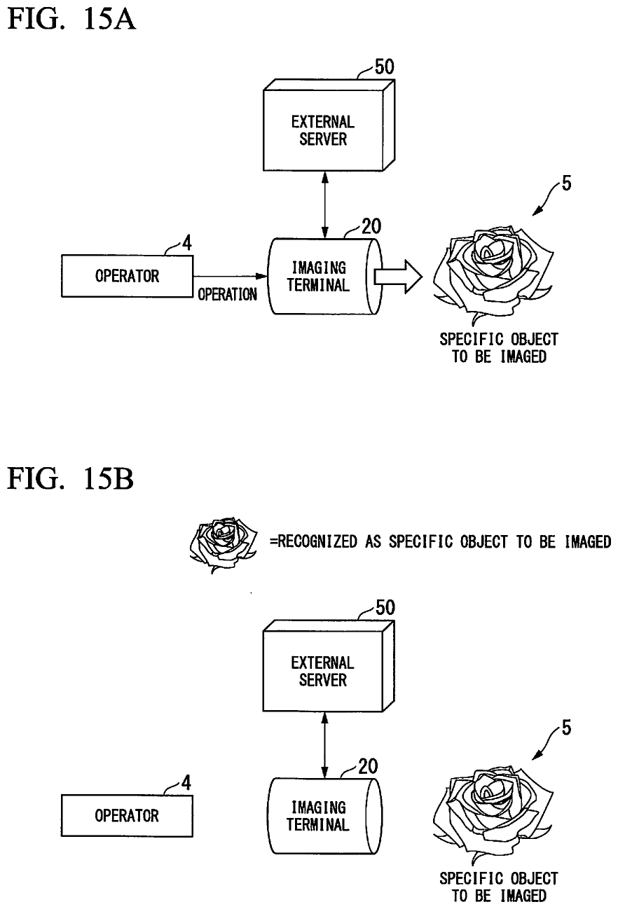

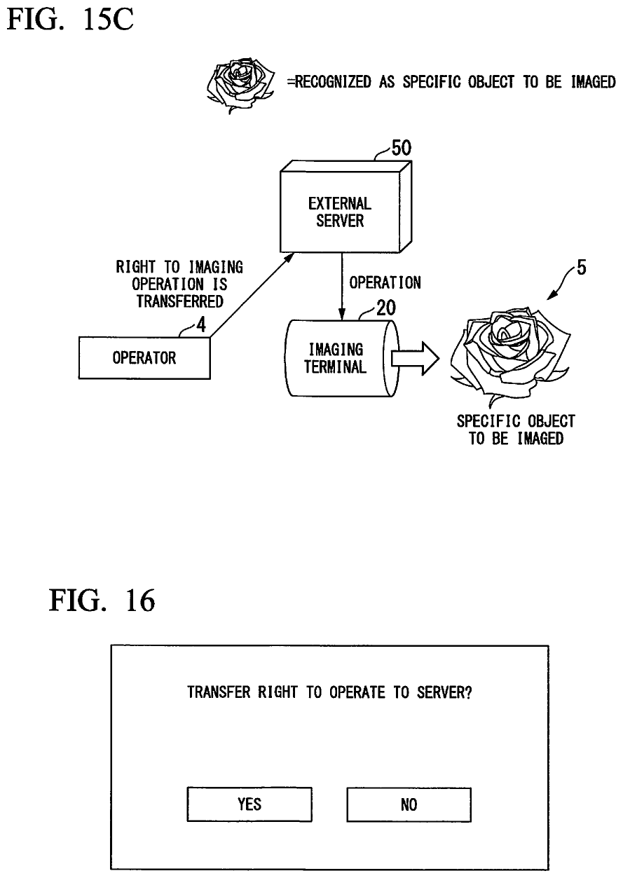

FIGS. 15A to 15C are images showing processes of an imaging method using the imaging system 1 according to the present embodiment. The imaging system 1 includes an imaging terminal (camera) 20 and an external server (external operation terminal) 50 that can communicate with the imaging terminal 20.

The imaging terminal (camera) 20 can capture an image by inputting the operation of the operator 4. At this time, as shown in FIG. 15A, first, the operator 4 operates the imaging terminal 20, and images are captured so that the specific imaging target 5 is within the captured image (in the imaging area). At this time, the operator 4 has the right of the imaging operation (the right to operate the imaging terminal 20).

Next, as shown in FIG. 15B, the imaging terminal 20 communicates with the external server (external operation terminal) 50, and the imaging system 1 (the imaging terminal 20 or the external server 50) determines whether or not the imaging condition of the specific object to be imaged 5 is satisfied. As an example, the imaging terminal 20 communicates with the external server 50, and the imaging system 1 (the imaging terminal 20 or the external server 50) recognizes (determines) whether or not there is a specific object to be imaged 5 as a subject in the captured image.

When the imaging system 1 (the imaging terminal 20 or the external server 50) recognizes that the imaging condition of the specific object to be imaged 5 is satisfied (the specific object to be imaged 5 is present as a subject in the captured image), as shown in FIG. 15C, the right of the imaging operation (the right to operate the imaging terminal 20) is transferred to the external server 50. Then, the external server 50 operates the imaging terminal 20 to capture the specific object to be imaged 5.

As described above, in the present embodiment, when the imaging terminal 20 determines that the imaging condition of the specific object to be imaged 5 is satisfied, the right to operate the imaging terminal 20 is transferred from the operator 4 to the external server 50. When the right to operate the imaging terminal 20 is transferred to the external server 50, the external server 50 performs an imaging operation of the specific object to be imaged 5 using (controlling) the imaging terminal 20, and receives the imaging data of the specific object to be imaged 5 from the imaging terminal 20.

That is, when the imaging terminal 20 that communicates with the external server 50 determines that the imaging condition of the specific imaging target is satisfied, the right to operate the imaging terminal 20 is transferred from the operator 4 to the external server 50. When the right to operate the imaging terminal 20 is transferred to the external server 50, the imaging terminal 20 performs an imaging operation of the specific object to be imaged 5 by the operation (control) of the external server 50, and transmits imaging data of the specific object to be imaged 5 to the external server 50.

In this way, taking the opportunity of recognizing or estimating that a specific subject (specific object to be imaged 5) is being photographed by some method, the right to operate the imaging terminal 20 is transferred to the external server 50. Thereby, the external server 50 can reliably acquire an image of the subject to be imaged (specific object to be imaged 5).

When special information such as a marker is arranged on or around the specific object to be imaged 5, the subject (specific object to be imaged 5) can be easily identified even when a plurality of similar subjects need to be captured. That is, the imaging terminal 20 recognizes the specific object to be imaged 5 by using the markers arranged on or around the specific object to be imaged 5. Here, special information such as markers can include information related to the imaging location (and camera settings, or the like.).

Even when no special information (such as a marker) for identifying a specific subject (specific object to be imaged 5) is arranged, it is possible to recognizing that a specific subject (specific object to be imaged 5) is photographed and to transfer the right to operate the imaging terminal 20 to the external server 50. That is, when the imaging terminal 20 recognizes a specific imaging target 5 based on the imaging data under a predetermined condition, the operating right of the imaging terminal 20 is transferred from the operator 4 to the external server 50. As described above, the right to operate can be transferred to the external server 50 after recognizing a specific subject (specific object to be imaged 5) without preparing special information (marker or the like) for identification.

The right to operate the imaging terminal 20 may be transferred from the operator 4 to the external server 50 when at least one of the position of the imaging terminal 20 or the orientation of the imaging terminal 20 satisfies a predetermined condition. In this case, a plurality of similar subjects can be identified without special information such as markers.

When the imaging terminal 20 determines that the specific object to be imaged 5 satisfies the predetermined condition in the captured image, a confirmation screen for transferring the right to operate the imaging terminal 20 may be presented on the monitor of the imaging terminal 20, and the right to operate the imaging terminal 20 may be transferred from the operator 4 to the external server 50 by the confirmation instruction of the operator 4 on the confirmation screen. FIG. 16 is a diagram showing an example of a confirmation screen for transferring the right to operate the imaging terminal 20 displayed on the monitor of the imaging terminal 20 in the imaging system 1 according to the present embodiment. In this case, the operator 4 can transfer the right to operate the imaging terminal 20 from the operator 4 to the external server 50 after the operator 4 considers the information other than the information held by the imaging system 1. The confirmation request for the transfer of the right to operate the imaging terminal 20 to the operator 4 may be made by notifying satisfaction of condition by voice or a tactile sense such as a vibrator, instead of displaying a confirmation screen on the monitor. The operator 4 can be confirmed to make an instruction by pressing the YES/NO button.

When the right to operate the imaging terminal 20 is transferred from the operator 4 to the external server 50 and the external server 50 performs an imaging operation using (controlling) the imaging terminal 20, the imaging terminal 20 may transmit the imaging data to the external server 50 without storing in the imaging terminal 20. In this case, by storing captured images only in the external server 50, the risk of information leakage and the like can be reduced.

In the imaging terminal 20, the position or orientation of the camera (imaging unit) can be changed, that is, at least one of rotation and movement of the camera (imaging unit) is possible. When the right to operate the imaging terminal 20 is transferred, the external server 50 may control the optical zoom, rotation, or movement of the camera so that the specific object to be imaged 5 is within the captured image (in the imaging area), to follow the specific object to be imaged 5. In this case, even when the operator 4 does not operate, the external server 50 can perform photographing under desired conditions.

Next, a configuration in which the controller (external operation terminal) 50 of the camera is separated from the imaging unit (imaging terminal) 20 and the external operation terminal 50 and the imaging unit (imaging terminal) 20 are configured to perform imaging by performing wireless connection will be described.

The external operation terminal 50 is connected to the imaging unit (imaging terminal) 20 via the wireless router 30 and performs remote control of the imaging unit 20 and the like. As described above, the external operation terminal 50 and the imaging unit 20 are separated, so that the degree of freedom of the camera angle is improved.

The imaging unit (imaging terminal) 20 can perform direct wireless communication (AP mode communication) with the external operation terminal 50. When the imaging unit 20 is performing AP mode communication, the operation of the operator 4 is input from the external operation terminal 50 to the imaging unit 20.

The imaging unit 20 can perform wireless communication (STA mode communication) with the external server 50 via the wireless router 30. When the right to operate the imaging unit 20 is transferred from the operator 4 to the external server 50, the AP mode communication is canceled and the STA mode connection between the imaging unit 20 and the external server 50 via the wireless router 30 is performed, and the external server 50 performs an imaging operation by controlling the imaging unit 20 via the wireless router 30.

Next, examples using the imaging system 1 of the present embodiment will be described.

### Example 1

The scene of Example 1 is to photograph in order at the imaging spots associated with each process according to the manual, in a series of inspection processes in the plant. As a condition, a fixed camera cannot be placed at the imaging location. In addition, since the camera photographs at a plurality of imaging locations, imaging conditions (such as exposure) change. The correct data of the subject or scene associated with the imaging spot of each inspection process is stored in the camera. Also, since images in the plant are highly confidential, it is necessary not to leave them in the imaging terminal.

The processing flow of the imaging system 1 under the above-described scene and conditions is as follows. First, the operator places the imaging terminal in an appropriate position of the imaging location, and adjusts the orientation of the imaging terminal so that the subject (scene) that needs to be photographed is within the imaging range based on the live view image of the imaging terminal and the intended composition is obtained. The imaging terminal identifies the subject (scene) from the live view image, and recognizes the imaging location and the subject that needs to be photographed (step S11). When the state where the recognition result coincides with the correct data is maintained for a certain period of time, it is determined that the imaging terminal can photograph, and the right to operate is transferred to the external server such as a control room or the like (step S12).

The external server performs such exposure setting and focus setting of the imaging terminal, to perform photographing (step S13). Further, the external server acquires a captured image from the imaging terminal and analyzes it, to determine whether or not the target image can be acquired (step S14). The images are transmitted to the external server, to be removed without stored the imaging terminal (step S15).

The external server returns the determination result to the imaging terminal (step S16). When the image has been acquired, the imaging terminal uses the correct data of the next process as a target to be collated, and a display prompting the user to proceed to the next process to photograph is displayed. When the image has not been acquired, a display prompting the user to re-install the imaging terminal is displayed (step S17).

The analysis by the external server indicates, for example, holding a model in which the subject and composition are machine-learned to collate with the correct subject and composition, and confirming whether or not exposure, contrast, and the like satisfy certain conditions. Further, at least a part of the analysis function on the external server, such as collation using the above learning model, may be performed on the camera side.

### Example 2

The scene of the second embodiment is that images are photographed in order in a series of inspection steps at a construction site at imaging spots associated with each step in accordance with a manual. As a condition, since it is a construction site, it is difficult to arrange a fixed camera. In addition, since the camera photographs at a plurality of imaging locations, imaging conditions (such as exposure) change.

The camera is equipped with a sensor capable of acquiring position information such as a GPS sensor, and can estimate position information of a photographer (imaging terminal) inside the construction site. Further, the camera is equipped with an orientation detection sensor such as a gravitational acceleration sensor, and the orientation of the camera can be estimated. The correct data relating to the position and orientation of the camera to be compared with the above information of the sensor is stored in advance in the camera by downloading or memory copying.

The camera is mounted on a module with an electric camera platform that can be remotely controlled. With the camera mounted on the electric camera platform, the user places it at the imaging location. The external server can control the movement of the electric camera platform.

The processing flow of the imaging system 1 under the above-described scene and conditions is as follows. First, the imaging terminal collates the GPS information and the orientation sensor information with the correct data, and determines whether or not a specific subject (structure) can be photographed (step S21). After the state in which the detection result matches with the correct data is kept for a constant time, button display is performed to confirm “whether or not to transfer the right to operate to the external server such as a control room” on the monitor of the imaging terminal (step S22). An example of the button display is shown in FIG. 16.

When the button is pressed, the imaging terminal transfers the right to operate to the external server (step S23). The external server performs such exposure setting and focus setting of the imaging terminal, to perform photographing (step S24). The external server receives the captured image from the imaging terminal to perform recognition of the subject and composition, and, depending on the result, controls the camera platform such that the camera is rotated or moved, so that the object to be imaged fits within the image (in the imaging area) (or so as to fine-tune the composition) (step S25). The adjustment is repeated until the condition is satisfied.

As a variation, a reference inspection is performed in advance, and a video of the structure is captured. Thereby, a three-dimensional model of the structure can be reconstructed from the video. A composition of an image expected to be photographed at the time of inspection is designated on the three-dimensional model. The position and orientation of the camera corresponding to the composition may be determined and used as correct data. From video data photographed during inspection, it is possible to improve the accuracy of the three-dimensional model.

### Example 3

The scene of the third embodiment is that, in a series of inspection processes at a construction site, images are photographed in order at imaging spots associated with each process by a camera that can communicate with a wireless terminal (such as a smartphone). As a condition, the wireless terminal operates only in the Wi-Fi STA mode (slave unit). The camera operates in one mode of either Wi-Fi AP mode or STA mode. In the AP mode, it can be connected to a wireless terminal on a one-to-one basis, and in the STA mode, it can be connected to a wireless terminal or an external server via a router. A QR code is attached to the imaging location of each process. A recognition engine for QR code is mounted on the wireless terminal. The correct data for collating QR code is stored in advance in the wireless terminal by downloading or memory copy.

The processing flow of the imaging system 1 under the above-described scene and conditions is as follows. First, the wireless terminal identifies the QR code from the live view image transmitted from the imaging terminal in the AP mode, and recognizes the imaging process (step S31). The wireless terminal instructs the imaging terminal to switch to the STA mode and to connect to a specific Wi-Fi router (step S32). The wireless terminal itself also temporarily disconnects from the imaging terminal and connects to the same Wi-Fi router (step S33). Thereafter, the identification information of the current imaging process is notified to the external server, and information for adjusting the position and orientation of the camera (for example, composition guidelines) is received (step S34).

Next, the wireless terminal is connected to the imaging terminal via the router, and the composition guideline is superimposed on the live view image and presented to the photographer (step S35). Then, a button for confirming whether or not to transfer the right to operate to the external server such as a control room is displayed on the monitor of the wireless terminal (step S36). When the button is pressed, the wireless terminal transmits a connection request to the camera to the external server (step S37). Then, the external server connects to the camera and performs setting and photographing (step S38).

In addition to decoding the content of the QR code, the approximate composition may be adjusted by detecting the position of the QR code in the screen of the wireless terminal (smartphone). The correct data may be stored in the camera. In that case, the wireless terminal notifies the wireless terminal, or inquires the camera at a certain time interval (not necessarily equal intervals), that the imaging condition is satisfied.

When the external server connects to the camera, the wireless terminal need not disconnect from the camera. The composition opportunity learning model may be downloaded to the wireless terminal, and the right to control may be automatically transferred to the external server when the position and orientation of the camera is adjusted in accordance with the approximate composition. What is superimposed on the live view image may be outline information (screw outline), position information (rebar arrangement) of a specific subject, or the like.

### Example 4

The scene of Example 4 is that the robot with a camera looks around the target person (inpatient, and the like) at the hospital, and when an abnormality occurs, the video is delivered to a nurse station or the like, or the patient status is recorded at the timing by a doctor or nurse. As a condition, the feature amount of the target person is registered in the robot, and a specific individual can be identified.

A primary recognition can be considered as follows. That is performed when a person is identified from physical characteristics (such as face and skeleton) obtained from images and sensors, when a specific movement is observed (or movement is observed) after a person is identified, or when a patient ID is identified by a QR code attached to the bedside or the like.

The robot is equipped with a camera (visible, infrared, or the like) and can be connected to the external server wirelessly via a router. The correct data for the primary recognition is stored in advance in the robot by downloading or memory copying.

The processing flow of the imaging system 1 under the above-described scene and conditions is as follows. First, the imaging terminal (robot) performs the primary recognition of the subject from the live view image to recognize the target person (step S41). When the state in which the recognition result matches with the registered target person is maintained for a certain period of time, it is determined that the target person can be photographed (in the state desired by the photographer), and the right to operate is transferred to the external server (step S42).

The external server starts video photographing of the target person (step S43). The external server analyzes the motion of the target person from the video frame in real time, and when a registered event such as an abnormality is detected, stores the video frame (step S44). Then, the external server transmits the stored video frame to the monitor of the nurse station, and updates the display (step S45).

When it is confirmed that there is no problem for a certain period of time, the robot is instructed to photograph the next subject, and the right to operate is transferred (step S46). The state where there is no problem is a state where a video frame is not displayed (abnormality is not detected), or a state where the display of the video frame is updated but a doctor or nurse confirms that there is no problem.

There is a security robot as a variation. When the security robot finds an abnormality during nighttime security in the building, it transfers the photographing timing to the security room. Alternately, when an abnormal condition of an animal is detected in a tour of the zoo or aquarium, the photographing timing is transferred to the keeper's station.

### Example 5

The scene of Example 5 is that, in a strawberry farm, the right to operate is transferred to the server when the camera recognizes the strawberry. The discovery of strawberry (primary recognition) is performed on the camera side. The server finely adjusts the composition and then judges the growth state from the captured image based on the result of image processing such as machine learning.

As a condition, the camera can move along a rail arranged along the crop. The camera is placed on the electric camera platform. The position of the camera and the electric camera platform on the rail can be controlled from the external server. The correct data for the primary recognition for determining whether or not there is a strawberry is prepared in the camera.

The processing flow of the imaging system 1 under the above-described scene and conditions is as follows. First, the imaging terminal periodically starts moving on the rail, and determines the presence or absence of strawberry from the live view image (step S51). When it is determined that the strawberry is found, the right to operate is transferred to the external server (step S52).

The external server specifies the position of the strawberry from the camera live image, and instructs adjustment of the camera position, orientation, and zoom as necessary (step S53). When the server determines that the intended composition is achieved, the server instructs the camera to photograph a strawberry (step S54). The server acquires the captured image from the camera and judges the growth state (step S55). When the judgement is completed, the camera is instructed to resume movement (step S56).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An imaging system comprising:
an imaging terminal; and
an external server that communicates with the imaging terminal,
wherein, when it is determined that the imaging terminal satisfies an imaging condition for a specific object to be imaged, the imaging system transfers a right to operate the imaging terminal from an operator to the external server, and,
when the right to operate is transferred to the external server, the external server controls a performance of an imaging operation by the imaging terminal for imaging the specific object to be imaged and receives imaging data of the specific object to be imaged from the imaging terminal.

2. The imaging system according to claim 1, wherein,
when the imaging terminal recognizes the specific object to be imaged based on the imaging data under a predetermined condition, the right to operate is transferred from the operator to the external server.

3. The imaging system according to claim 2, wherein the imaging terminal recognizes the specific object to be imaged by a marker disposed on or around a surface of the s specific object to be imaged.

4. The imaging system according claim 1, wherein,
when at least one of a position of the imaging terminal and an orientation of the imaging terminal meets a predetermined condition, the right to operate the imaging terminal is transferred from the operator to the external server.

5. The imaging system according to claim 1, wherein,
when the imaging terminal determines that the specific object to be imaged satisfies a predetermined condition, a confirmation screen for transferring the right to operate is presented on a monitor of the imaging terminal, and the right to operate the imaging terminal is transferred from the operator to the external server by the operator's confirmation instruction on the confirmation screen.

6. The imaging system according to claim 1, wherein,
when the right to operate is transferred from the operator to the external server and the external server is performing the imaging operation using the imaging terminal, the imaging terminal transmits the imaging data to the external server without storing the imaging data in the imaging terminal.

7. The imaging system according to claim 1, wherein
the imaging terminal is capable of AP mode communication that is direct wireless communication with an external operation terminal,
an operation of the external operation terminal by the operator is input from the external operation terminal to the imaging terminal,
the imaging terminal is capable of STA mode communication that is wireless communication via a router with the external server, and,
when transferring the right to operate the imaging terminal from the operator to the external server, the AP mode communication is canceled and the STA mode communication is performed to connect between the imaging terminal and the external server via the router, and the external server performs the imaging operation by controlling the imaging terminal via the router.

8. The imaging system according to claim 1, wherein the imaging terminal is capable of at least one of rotating and moving of an imaging part of the imaging terminal, and,
when the right to operate is transferred, the external server follows the specific object to be imaged by optically zooming, rotating, or moving the imaging part so that the specific object to be imaged is within an imaging area of the imaging part.

9. An imaging terminal that communicates with an external server in an imaging system, wherein,
when it is determined that the imaging terminal satisfies an imaging condition for a specific object to be imaged, a right to operate the imaging terminal is transferred from an operator to the external server, and
when the right to operate is transferred to the external server, the imaging terminal performs an imaging operation of the specific object to be imaged under a control of the external server, and transmits imaging data of the specific object to be imaged to the external server.

10. An imaging method in an imaging system including an imaging terminal and an external server communicating with the imaging terminal, the imaging method comprising:
when it is determined that the imaging terminal satisfies an imaging condition for a specific object to be imaged, transferring a right to operate the imaging terminal from an operator to the external server; and,
when the right to operate is transferred to the external server, performing, by the external server, an imaging operation of the specific object to be imaged using the imaging terminal, and transmitting imaging data of the specific object to be imaged from the imaging terminal to the external server.

11. A non-transitory computer-readable recording medium that stores a computer program, when executed by a computer, to cause an imaging system including an imaging terminal and an external server communicating with the imaging terminal to execute:
when it is determined that the imaging terminal satisfies an imaging condition for a specific object to be imaged, transferring a right to operate the imaging terminal from an operator to the external server; and,
when the right to operate is transferred to the external server, performing, by the external server, an imaging operation of the specific object to be imaged using the imaging terminal, and transmitting imaging data of the specific object to be imaged from the imaging terminal to the external server.
